(19) United States
(12) Patent Application Publication
(10) Pub. No.: US 2016/0080208 A1
(43) Pub. Date: Mar. 17, 2016

(54) MASTER STATION DEVICE, SLAVE STATION DEVICE, OPTICAL COMMUNICATION SYSTEM, CONTROL DEVICE, AND BANDWIDTH ALLOCATION METHOD

(71) Applicant: MITSUBISHI ELECTRIC CORPORATION, Chiyoda-ku, Tokyo (JP)

(72) Inventors: Yuta TAKEMOTO, Tokyo (JP); Takashi NISHITANI, Tokyo (JP)

(73) Assignee: MITSUBISHI ELECTRIC CORPORATION, Chiyoda-ku, Tokyo (JP)

(21) Appl. No.: 14/888,504

(22) PCT Filed: Apr. 28, 2014
(86) PCT No.: PCT/JP2014/061876

§ 371 Date: Nov. 2, 2015

(30) Foreign Application Priority Data
May 2, 2013 (JP) 2013-096894

(51) Int. Cl. H04L 12/24; H04L 12/927; H04Q 11/00; H04L 12/911

(52) U.S. Cl. CPC H04L 41/0896; H04L 47/826; H04L 47/805; H04Q 11/0067; H04Q 2011/0086

(57) ABSTRACT

Included are a report-frame analysis unit that extracts a requested bandwidth from a report frame; an upload-bandwidth calculation unit that calculates the upload bandwidth; a residual-time calculation unit that acquires the residual time of each LLID before an allowable delay time; a priority calculation unit that acquires a priority of a data request corresponding to the report frame on the basis of the residual time; a report-request registration unit that generates a report request requesting allocation of an upload bandwidth for a report frame and that decides the priority of the report request; an allocation-order reading unit that decides the allocation order for the data request and the report request on the basis of the priority; and a gate-frame creation unit that decides a transmission-permitted time slot for each LLID on the basis of the allocation order and the upload bandwidth and that creates a gate frame.

### FIELD

The present invention relates to a master station device, a slave station device, an optical communication system, a control device, and a bandwidth allocation method.

### BACKGROUND

A PON (Passive Optical Network) system is used as an access-system network that connects homes, businesses, or other locations to an upper network. The PON system connects a master station device (hereinafter, “OLT (Optical Line Terminal)”) with a plurality of slave station devices (hereinafter, “ONU (Optical Network Unit)”) in one-to-multiple connections by optical fiber and by using a splitter. With the PON system with the one-to-multiple connections as described above, when upload data communication from the ONU to the OLT is to be performed, the ONU transmits to the OLT a bandwidth request signal requesting bandwidth be allocated to a device in the ONU, or OLT, so that upload data communication can happen. On the basis of a bandwidth request signal from each ONU, the OLT allocates a bandwidth (a transmission-permitted time slot) to each ONU, and transmits a transmission permission signal indicating a transmission start time and a transmission time period, which is a result of the allocation to each ONU. Thereafter, the ONU receives the transmission permission signal addressed to a device in the ONU from the OLT, and it transmits upload data according to the specifics of the transmission permission signal. With the PON system, the bandwidth allocation process as described above is performed on upload data communication.

DBA (Dynamic Bandwidth Allocation) is a commonly known bandwidth allocation method. The DBA is a bandwidth allocation method, in which the OLT receives a requested bandwidth from each ONU, and dynamically allocates a communication bandwidth for each ONU on the basis of the requested bandwidth. Particularly, a method to decide the bandwidth to be allocated according to the queue length requested from each ONU is referred to as “SR (Status Reporting)-DBA”. In the SR-DBA, the bandwidth to be allocated is updated in a given cycle. In the SR-DBA, this cycle may be fixed or may be variable (see, for example, Patent Literatures 1 and 2).

### CITATION LIST

### Patent literatures

Patent Literature 1: Japanese Patent No. 3768422

Patent Literature 2: Japanese Patent Application Laid-open No. 2012-175269

### SUMMARY

### Technical Problem

There are, however, various delay guarantee classes in a PON system. When the conventional technique described above is applied to a PON system to allocate a bandwidth in a given cycle (a bandwidth allocation cycle), bandwidth allocation is supposed to be performed in synchronization with the minimum delay time in order to keep the delay time stable. The delay guarantee class is a class that indicates the duration of the guaranteed delay time. The guaranteed delay time (a delay guarantee time) is decided according to the service to be provided or other factors. In a case where there are various delay guarantee classes, when bandwidth allocation is performed in synchronization with the minimum delay time, the bandwidth allocation cycle is shorter than necessary for data transmission in a delay guarantee class with a more flexible delay-time request. An optical burst signal to be transmitted in the PON system is accompanied by an overhead which is in addition to data to be transmitted and which corresponds to the time required for turning on/off an optical transmitter-receiver and the synchronization time required for frame synchronization. Therefore, as the number of bursts per unit time is increased, in proportion to this increase, the burst overhead is increased, and accordingly the user data throughput is decreased. Thus, when bandwidth allocation is performed in a bandwidth allocation cycle that is shorter than necessary, the bandwidth usage efficiency is reduced, which causes a shortage of bandwidth. This results in a problem in that the delay time cannot be guaranteed.

A conceivable way of solving this problem is to use a plurality of different bandwidth allocation cycles to perform bandwidth allocation to ONUs in each of the different bandwidth allocation cycles. For example, bandwidth allocation is performed on a first ONU with a shorter guaranteed delay time in a bandwidth allocation cycle A, and bandwidth allocation is performed on a second ONU with a longer guaranteed delay time in a bandwidth allocation cycle B (A<B). In this manner, however, a conflict may occur with the allocated upload bandwidth between the bandwidth allocation using the bandwidth allocation cycle A and the bandwidth allocation using the bandwidth allocation cycle B. In this case, there is a problem in that there will be an ONU to which an upload bandwidth is not allocated, and the delay time cannot be guaranteed.

The present invention has been achieved to solve the above problems, and an objective of the present invention is to provide a master station device, a slave station device, an optical communication system, a control device, and a bandwidth allocation method that can guarantee a delay time and improve bandwidth usage efficiency in a case where there are various delay guarantee classes.

### Solution to Problem

In order to solve the problem and achieve the objective, the present invention relates to 1. a master station device that is connected to one or more slave station devices through an optical communication path and that allocates a bandwidth for communication in an upload direction, which is a direction from the slave station devices toward the master station device itself, to each of the slave station devices per logical link, the master station device. The master station device includes: an analysis unit that receives a bandwidth request signal requesting a bandwidth for transmitting upload data from the slave station device, and that extracts a requested bandwidth of each logical link from the bandwidth request signal; a bandwidth calculation unit that calculates an upload bandwidth for transmitting the upload data on the basis of the requested bandwidth; a residual-time calculation unit that holds an allowable delay time for each logical link for communication in an upload direction, and that acquires a residual time of each logical link on the basis of the allowable delay time and an estimated value of a time for which the upload data stays in the slave station device; a priority calculation unit that acquires a priority of a bandwidth allocation request for transmitting the upload data, which is requested by the bandwidth request signal, on the basis of the residual time of each logical link; a bandwidth-request generation unit that generates a bandwidth allocation request, which requests allocation of an upload bandwidth for transmitting a bandwidth request signal, for each logical link and that decides a priority of a generated bandwidth allocation request; an allocation-order decision unit that decides an allocation order corresponding to the bandwidth allocation request on the basis of the priority; and a transmission-permission generation unit that decides a transmission-permitted time slot corresponding to the bandwidth allocation request on the basis of the allocation order and on the basis of the upload bandwidth in each of the bandwidth allocation requests, and that notifies the slave station device of the transmission-permitted time slot.

### Advantageous Effects of Invention

The present invention can guarantee a delay time and improve bandwidth usage efficiency in a case where there are various delay guarantee classes.

### BRIEF DESCRIPTION OF DRAWINGS

FIG. 1 is a diagram illustrating an example configuration of a PON system (an optical communication system) according to the present invention.

FIG. 2 is a diagram illustrating an example configuration of an ONU.

FIG. 3 is a diagram illustrating an example of a PON system in which there are LLIDs (Logical Link ID (IDentifier)) having different delay guarantee classes.

FIG. 4 is a diagram illustrating an operation example of bandwidth allocation when a bandwidth allocation cycle is set in synchronization with the minimum delay time.

FIG. 5 is a diagram illustrating an example of a bandwidth allocation result when a bandwidth allocation cycle is set in synchronization with the minimum delay time.

FIG. 6 is a diagram illustrating an example of a bandwidth allocation result when a plurality of different bandwidth allocation cycles are used.

FIG. 7 is a diagram illustrating an example of a bandwidth allocation result according to an embodiment.

FIG. 8 is a flowchart illustrating an example procedure of a bandwidth allocation process according to the embodiment.

FIG. 9 is a diagram illustrating an example configuration of an allocation order table.

FIG. 10 is an explanatory diagram of an elapsed time since the last report reception.

FIG. 11 is an explanatory diagram of the effects of the embodiment.

### DESCRIPTION OF EMBODIMENTS

Exemplary embodiments of a master station device, a slave station device, an optical communication system, a control device, and a bandwidth allocation method according to the present invention will be explained below in detail with reference to the accompanying drawings. Note that the present invention is not limited to the embodiments.

### Embodiment

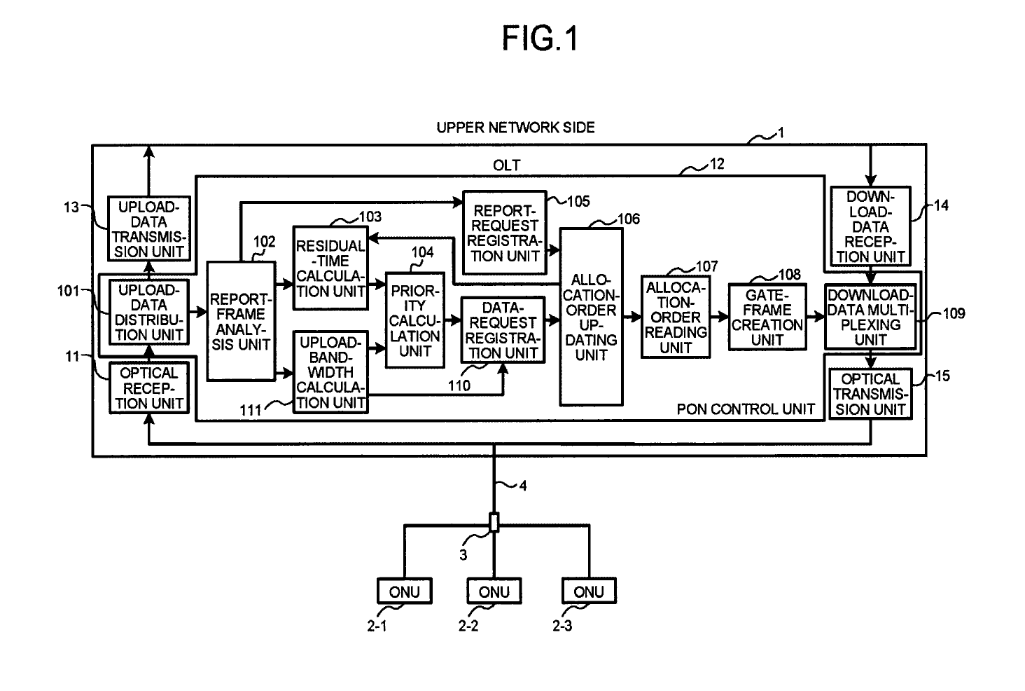

FIG. 1 is a diagram illustrating an example configuration of a PON system (an optical communication system) according to the present invention. The optical communication system according to the present invention is described below using the PON system as an example. As illustrated in FIG. 1, the PON system according to an embodiment of the present invention includes a station-side optical communication device (also referred to as an “Optical Line Terminal”, and hereinafter, “OLT”) 1 that operates as a master station device; and a plurality of user-side optical communication devices (also referred to as “Optical Network Units”, and hereinafter, “ONUs”) 2-1 to 2-3 that operate as slave station devices. The OLT 1 is connected to the ONUs 2-1 to 2-3 via an optical fiber 4 and a coupler 3. While FIG. 1 illustrates three ONUs as an example, the number of ONUs is not limited thereto. The PON system according to the present embodiment can be a GE-PON system based on IEEE (The Institute of Electrical and Electronics Engineers) 802.3ah, or it can be a G-PON system based on ITU-T (International Telecommunication Union Telecommunication Standardization Sector) G.983.1. While the PON system is described below as an example, the present invention is not limited to the PON system. The present invention can be applied to a system other than a PON system as long as the system is an optical communication system in which a master station device allocates bandwidth to a slave station device. Further, the present invention can be applied to a communication system other than the optical communication system as long as the system is a communication system in which a master station device allocates bandwidth to a slave station device.

FIG. 1 also illustrates an example configuration of the OLT 1 according to the present embodiment. As illustrated in FIG. 1, the OLT 1 includes an optical reception unit 11, a PON control unit (control device) 12, an upload-data transmission unit 13, a download-data reception unit 14, and an optical transmission unit 15. The PON control unit 12 includes an upload-data distribution unit 101, a report-frame analysis unit (analysis unit) 102, a residual-time calculation unit 103, a priority calculation unit 104, a report-request registration unit (bandwidth-request generation unit) 105, an allocation-order updating unit (allocation-information updating unit) 106, an allocation-order reading unit (allocation-order decision unit) 107, a gate-frame creation unit (transmission-permission generation unit) 108, a download-data multiplexing unit 109, a data-request registration unit (data-request generation unit) 110, and an upload-bandwidth calculation unit (bandwidth calculation unit) 111. FIG. 1 illustrates an example in which the upload-data distribution unit 101 and the download-data multiplexing unit 109 are provided within the PON control unit 12. However, one or both of the upload-data distribution unit 101 and the download-data multiplexing unit 109 can be provided outside of the PON control unit 12.

The optical reception unit 11 receives an optical signal transmitted from the ONUs 2-1 to 2-3 and converts the optical signal to an electrical signal. The upload-data distribution unit 101 in the PON control unit 12 distributes upload data from each of the ONUs 2-1 to 2-3 (an electrical signal input from the optical reception unit 11) among user data (a user-data frame) and control data (a control-data frame); outputs the user data (the upload data) to the upload-data transmission unit 13; and outputs a report frame (also referred to as “report message”) in the control-data frame to the report-frame analysis unit 102. A report frame is a bandwidth request frame (a bandwidth request signal) transmitted from each ONU. In the report frame, the transmission queue length (requested bandwidth) of user data in a transmission-source ONU is stored. When bandwidth allocation is performed per LLID (Logical Link ID (IDentifier)), a report frame of each LLID is transmitted. An example is described below in which bandwidth allocation to each LLID is performed. When bandwidth allocation is performed per ONU, each individual ONU can be thought of as corresponding to each individual LLID. In the present embodiment, bandwidth allocation operation is primarily described. Therefore, FIG. 1 illustrates constituent elements that process a bandwidth allocation-related frame as a control-data frame. Because a configuration and an operation for processing other control data are not particularly limited, illustrations of constituent elements that process other control data are omitted, and therefore descriptions of the operation are also omitted.

The upload-data transmission unit 13 transmits user data that is input from the upload-data distribution unit 101 to an upper network. The report-frame analysis unit 102 analyzes a report frame; extracts the accumulating transmission queue of each LLID in each ONU; outputs it to the upload-bandwidth calculation unit 111; and notifies the residual-time calculation unit 103 of the report-frame receiving time. The upload-bandwidth calculation unit 111 calculates an upload bandwidth (the transmission-permitted duration) to be allocated to each LLID on the basis of the accumulating transmission queue of each LLID and also on the basis of the upload-communication data rate. The residual-time calculation unit 103 calculates the residual time of each LLID in each ONU on the basis of the report-frame receiving time. The residual time is the remaining time to complete a guaranteed delay time. The priority calculation unit 104 calculates a bandwidth-allocation priority for the user data of each LLID on the basis of the upload bandwidth calculated by the upload-bandwidth calculation unit 111 and also on the basis of the residual time calculated by the residual-time calculation unit 103. The report-request registration unit 105 establishes an association between information indicative of a report request, an LLID, a priority decided on the basis of a delay guarantee class preset for each LLID, and a bandwidth for a report, and it registers them in an allocation order table within the allocation-order updating unit 106. The data-request registration unit 110 establishes an association between information indicative of a data request, an LLID, a priority calculated by the priority calculation unit 104, and the allocated upload bandwidth for each LLID, and it registers them in the allocation order table. The allocation-order updating unit 106 holds the allocation order table; updates the priority of each of the entries (bandwidth allocation requests) registered in the allocation order table; and sorts the entries in order of the highest priority.

The allocation-order reading unit 107 reads out information on an entry in order of the highest priority from the allocation order table (that is, decides the allocation order for each bandwidth allocation request), and outputs the read information to the gate-frame creation unit 108. The allocation-order reading unit 107 deletes an entry that has already read from the allocation order table. The timing, at which the allocation-order reading unit 107 reads an entry, can be set to any timing. For example, the timing can be set such that when creation of a gate frame of the last entry is finished, the allocation-order reading unit 107 can read the next entry, or upon updating the allocation order table, the allocation-order reading unit 107 can read an entry with the highest priority in the allocation order table. The gate-frame creation unit 108 creates a gate frame that notifies each LLID of a bandwidth allocation result (a transmission-permitted time slot) on the basis of the information input from the allocation-order reading unit 107, and it outputs the gate frame to the download-data multiplexing unit 109. The gate frame (or a grant frame) is a transmission permission signal that notifies a time slot in which transmission in the upload direction is permitted. In the gate frame, the transmission-permitted time slot (for example, a transmission start time and a transmission time period) is stored. At this time, in the gate frame, information indicating whether the gate frame is a bandwidth allocation result for user data transmission or a bandwidth allocation result for a report frame can be stored. While an example in which a gate frame is used as a transmission permission signal that indicates a bandwidth allocation result is described herein, a transmission permission signal in other forms such as a grant frame can also be used.

The download-data multiplexing unit 109 multiplexes a gate frame and user data received from the download-data reception unit 14, and it outputs them to the optical transmission unit 15. The optical transmission unit 15 converts a signal input from the download-data multiplexing unit 109 into an optical signal, and it transmits the optical signal to the ONUs 2-1 to 2-3.

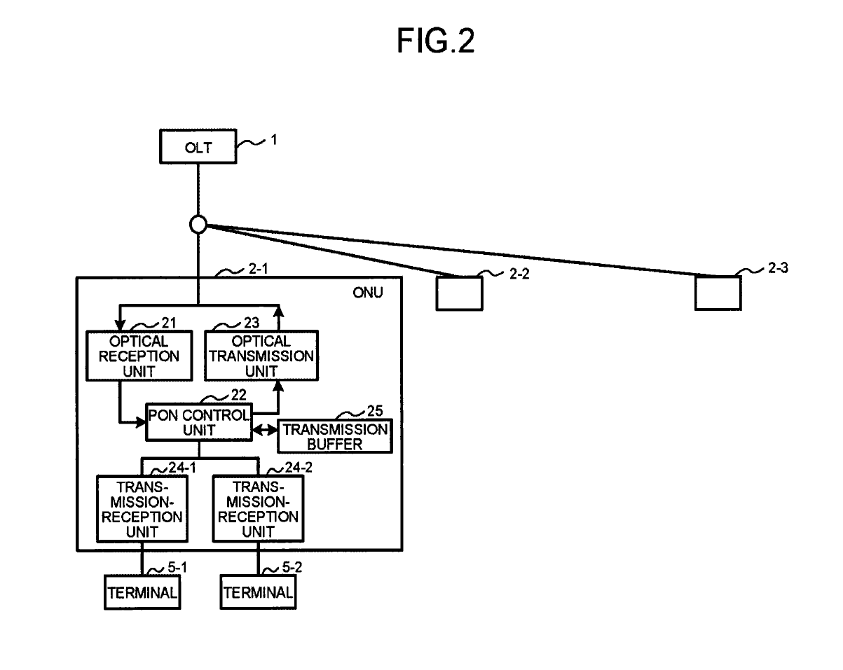

FIG. 2 is a diagram illustrating an example configuration of the ONU 2-1 according to the present embodiment. As illustrated in FIG. 2, the ONU 2-1 includes an optical reception unit 21, a PON control unit (control device) 22, an optical transmission unit 23, transmission-reception units 24-1 and 24-2, and a transmission buffer 25. The ONU 2-1 is connected to terminals 5-1 and 5-2. While FIG. 2 illustrates an example in which the ONU 2-1 is connected to two terminals, the number of connecting terminals is not limited thereto. The ONUs 2-2 and 2-3 also have a configuration identical to the ONU 2-1.

The optical reception unit 21 converts an optical signal transmitted from the OLT 1 into an electrical signal and then transmits the electrical signal to the PON control unit 22. The PON control unit 22 distributes the electrical signal received from the optical reception unit 21 to control data and user data (download data), and then it outputs the user data to the transmission-reception unit 24-1 or 24-2 corresponding to the address of the user data. The transmission-reception units 24-1 and 24-2 transmit the user data to the terminals 5-1 and 5-2, respectively.

The transmission-reception units 24-1 and 24-2 store user data (upload data), received respectively from the terminals 5-1 and 5-2, in the transmission buffer 25 via the PON control unit 22. In the transmission buffer 25, a transmission queue is set up for each LLID. When information indicating whether the gate frame is a bandwidth allocation result for user data transmission or a bandwidth allocation result for a report frame is stored, the PON control unit 22 determines, on the basis of this information, whether the gate frame is a bandwidth allocation result for user data transmission or a bandwidth allocation result for a report frame. When this information is not stored, the PON control unit 22 determines, for example, whether the gate frame is a bandwidth allocation result for a report frame on the basis of whether the transmission time period is equal to or less than a given value. When the gate frame indicates bandwidth allocation for user data, the PON control unit 22 reads the user data of each LLID from the transmission buffer 25 on the basis of the transmission start time and the transmission time period that are stored in the gate frame, which is one of the types of control data received from the OLT 1. The PON control unit 22 then outputs the read user data to the optical transmission unit 23. When the gate frame indicates bandwidth allocation for a report frame, the PON control unit 22 transmits a report frame on the basis of the transmission start time and the transmission time period that are stored in the gate frame. Further, the PON control unit 22 monitors the transmission queue length of each LLID in the transmission buffer 25, generates a report frame for each LLID, each report frame having the transmission queue length stored therein, and outputs the report frame to the optical transmission unit 23 on the basis of the transmission start time and the transmission time period that the gate frame indicates. The optical transmission unit 23 converts the data received from the PON control unit 22 to an optical signal and transmits the optical signal to the OLT 1.

Conventional bandwidth allocation in a PON system, in which there are various delay guarantee classes, is described here. The delay guarantee class is a class that is set according to a guaranteed delay time. The guaranteed delay time is set according to, for example, the service type (such as VoIP (Voice over Internet Protocol) or Video).

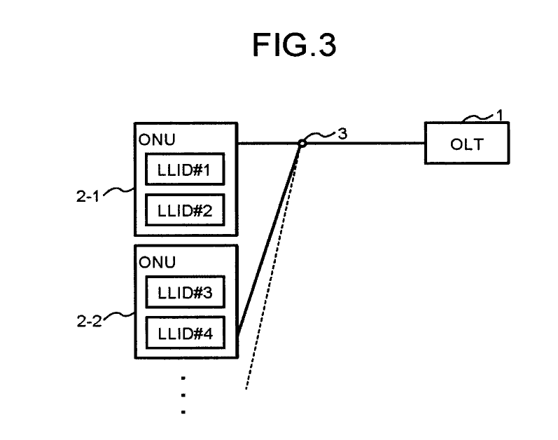

FIG. 3 is a diagram illustrating an example of the PON system in which there are LLIDs having different delay guarantee classes. FIG. 3 illustrates an example in which, in the PON system illustrated in FIGS. 1 and 2, each of the ONU 2-1 and the ONU 2-2 has a plurality of LLIDs; and a delay guarantee class is set up for each of the LLIDs. The ONU 2-1 has an LLID #1 and an LLID #2. The guaranteed delay time for the LLID #1 is 3 milliseconds. The guaranteed delay time for the LLID #2 is 1 millisecond. The ONU 2-2 has an LLID #3 and an LLID #4. The guaranteed delay time for the LLID #3 is 3 milliseconds. The guaranteed delay time for the LLID #4 is 1 millisecond.

In the PON system, when user data to be transmitted is generated, an ONU transmits a bandwidth request signal (a report frame) requesting allocation of an upload bandwidth for an OLT; and then the OLT allocates an upload bandwidth to the ONU on the basis of the bandwidth request signal from the ONU. In each given cycle (each bandwidth allocation cycle), the OLT performs allocation of an upload bandwidth within the next bandwidth allocation cycle, and notifies the ONU of the result of the allocation. Therefore, the delay time to transmit user data from the ONU depends on the bandwidth allocation cycle.

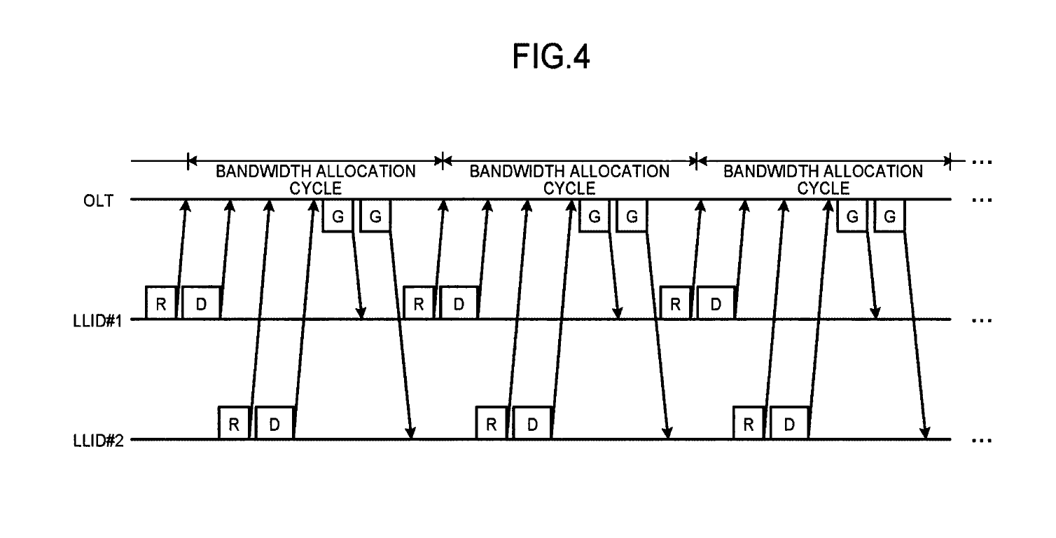

A conceivable method of guaranteeing the delay time, in a case where there are various delay guarantee classes, is to set a bandwidth allocation cycle in synchronization with the minimum delay time. FIG. 4 is a diagram illustrating an operation example of bandwidth allocation when the bandwidth allocation cycle is set in synchronization with the minimum delay time. For the sake of simplicity, FIG. 4 illustrates an example in which only the ONU 2-1 (the LLID #1 and the LLID #2) in FIG. 3 is operating. In this example, the bandwidth allocation cycle is set to 1 millisecond in synchronization with the shorter guaranteed delay time of the LLID #2 among the LLID #1 and the LLID #2. In FIG. 4, “R” represents a report frame, “G” represents a gate frame, and “D” represents data (upload user data). FIG. 4 illustrates an example in which bandwidth allocation is performed on each LLID in such a manner that the upload bandwidth for a report frame and the upload bandwidth for data are allocated consecutively. A report frame for each LLID is transmitted. In the report frame, the transmission queue length is stored. A report frame for the LLID #1 and a report frame for the LLID #2 are both transmitted in each bandwidth allocation cycle (1 millisecond in this example). Even in the LLID #1 to which the guaranteed delay time is 3 milliseconds, data is still transmitted in a cycle equal to or shorter than 1 millisecond when the transmission queue length is not 0.

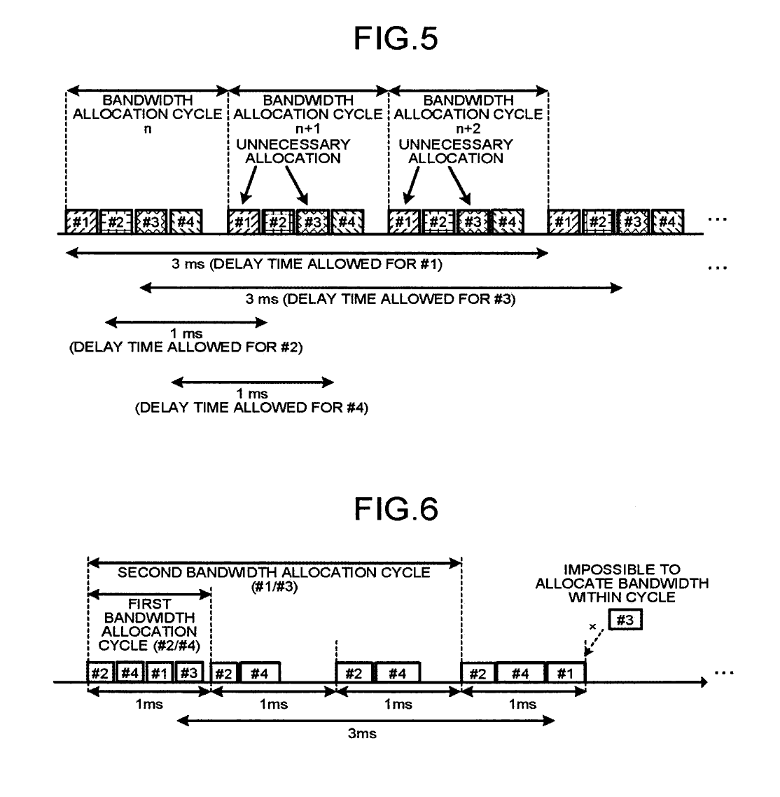

FIG. 5 is a diagram illustrating an example of a bandwidth allocation result when the bandwidth allocation cycle is set in synchronization with the minimum delay time. FIG. 5 is based on the configuration illustrated in FIG. 3. In FIG. 5, for the sake of simplicity, the LLID #1, the LLID #2, the LLID #3, and the LLID #4 are abbreviated as #1, #2, #3, and #4, respectively. As is the case in FIG. 4, FIG. 5 illustrates an example in which bandwidth allocation is performed on each LLID such that an upload bandwidth for a report frame and an upload bandwidth for data are allocated consecutively. In FIG. 5, the allocation result for each LLID (an allocated upload bandwidth) is indicated by a square with the LLID number (such as #1) illustrated in the square in which an upload bandwidth allocated to a report frame and an upload bandwidth allocated to data are merged into one.

It is assumed that among three bandwidth allocation cycles from the n-th to (n+2)-th bandwidth allocation cycles, in the n-th bandwidth allocation cycle, a report frame is transmitted in which the transmission queue length related to user data of each LLID is stored. The arrows illustrated in FIG. 5, which represent a delay such as “3 milliseconds (the delay time allowed for #1)”, indicate an allowable delay time from the point in time when user data is generated (which is substantially equal to the point in time when a report frame is transmitted, in which the transmission queue length related to user data is stored) to the point in time when the user data is transmitted. In practice, a time period from when an ONU receives upload user data to when the ONU transmits a report frame is added as a delay time. However, in this example, for the sake of simplicity of the descriptions, the time period from receiving user data to transmitting a report frame is assumed to be almost zero. As illustrated in FIG. 5, in the LLID #1 and the LLID #3, data transmission is performed with a delay time (1 millisecond) shorter than their allowable delay times (3 milliseconds).

An optical burst signal to be transmitted in the PON system is accompanied by overhead which corresponds to the time required for turning on/off an optical transmitter-receiver, and the synchronization time required for frame synchronization, in addition to data to be transmitted. Therefore, as the number of bursts per unit time is increased, in proportion to this increase, the burst overhead amount is increased, and accordingly the user data throughput is decreased. Therefore, as illustrated in the example of the LLID #1 and the LLID #3 in FIG. 5, when bandwidth allocation is performed in a bandwidth allocation cycle that is shorter than necessary as compared to the allowable delay time (3 milliseconds), the bandwidth usage efficiency is decreased.

In order to prevent the decrease in bandwidth usage efficiency as described above, it is conceivable to use a plurality of different bandwidth allocation cycles. FIG. 6 is a diagram illustrating an example of a bandwidth allocation result when a plurality of different bandwidth allocation cycles are used. Similar to FIG. 5, FIG. 6 is on the basis of the configuration illustrated in FIG. 3. In FIG. 6, in the same manner as FIG. 5, for the sake of simplicity, the LLID #1, the LLID #2, the LLID #3, and the LLID #4 are abbreviated as #1, #2, #3, and #4, respectively. Similar to FIGS. 4 and 5, FIG. 6 illustrates an example in which bandwidth allocation is performed on each LLID in such a manner that an upload bandwidth for a report frame and an upload bandwidth for data are allocated consecutively.

In the example in FIG. 6, the OLT 1 sets a bandwidth allocation cycle to each delay guarantee class, and performs bandwidth allocation to each delay guarantee class. Specifically, in the example in FIG. 6, an upload bandwidth is allocated to the LLID #2 and the LLID #4 in a first bandwidth allocation cycle (1 millisecond), and an upload bandwidth is allocated to the LLID #1 and the LLID #3 in a second bandwidth allocation cycle (3 milliseconds), that is, in the initial first bandwidth allocation cycle within the second bandwidth allocation cycle. In this case, in the initial first bandwidth allocation cycle within the second bandwidth allocation cycle, an upload bandwidth is allocated to the LLIDs #1, #2, #3, and #4. As illustrated in the example in FIG. 6, when the LLID #4 has a greater transmission queue length, an upload bandwidth cannot be allocated to the LLID #3 as illustrated at the right end in FIG. 6. Therefore, bandwidth allocation is performed on the LLID #3 in the next second bandwidth allocation cycle. Although bandwidth allocation is performed on the LLID #3 in the next second bandwidth allocation cycle, the delay time of the LLID #3 exceeds its allowable delay time.

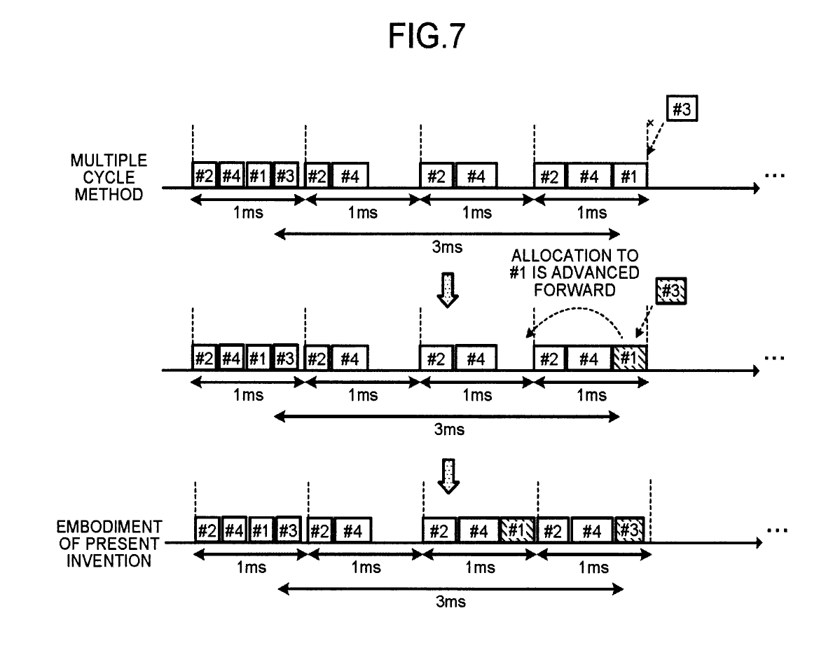

In the present embodiment, in order to guarantee the delay time while preventing a decrease in user data throughput, a bandwidth allocation process is performed as described below in such a manner that a priority is set to a report frame and user data so as to satisfy the allowable delay time, and an upload bandwidth is allocated in order of the highest priority. FIG. 7 is a diagram illustrating an example of a bandwidth allocation result according to the present embodiment. FIG. 7 illustrates, at the top segment, an allocation result from a method using multiple different bandwidth allocation cycles (a multiple cycle method) illustrated in FIG. 6. In the bandwidth allocation process according to the present embodiment, as illustrated at the middle segment of FIG. 7, allocation of the final upload bandwidth for the LLID #1 can be advanced forward. This makes it possible to allocate an upload bandwidth (the right-end upload bandwidth) to the LLID #3 as illustrated at the bottom segment in FIG. 7, which cannot be achieved in the multiple cycle method.

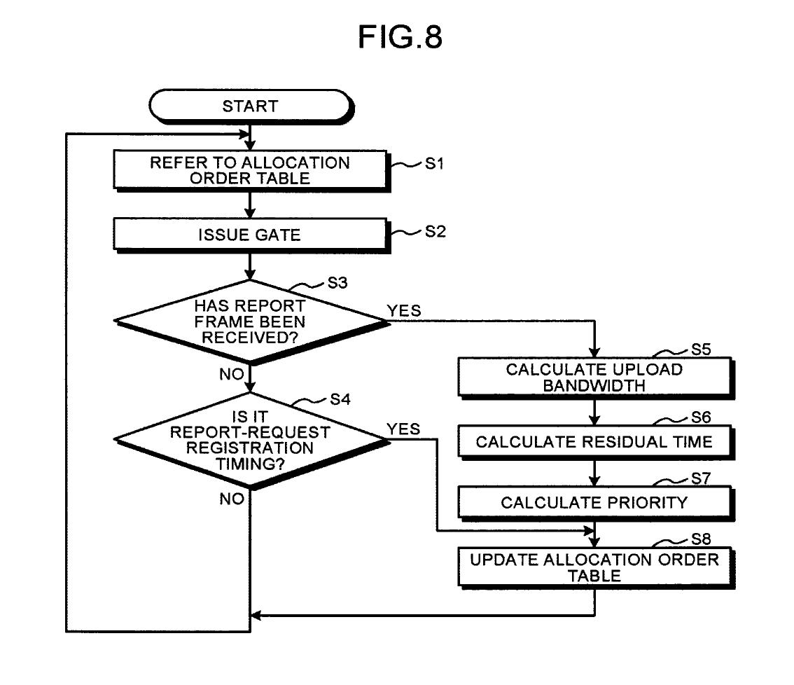

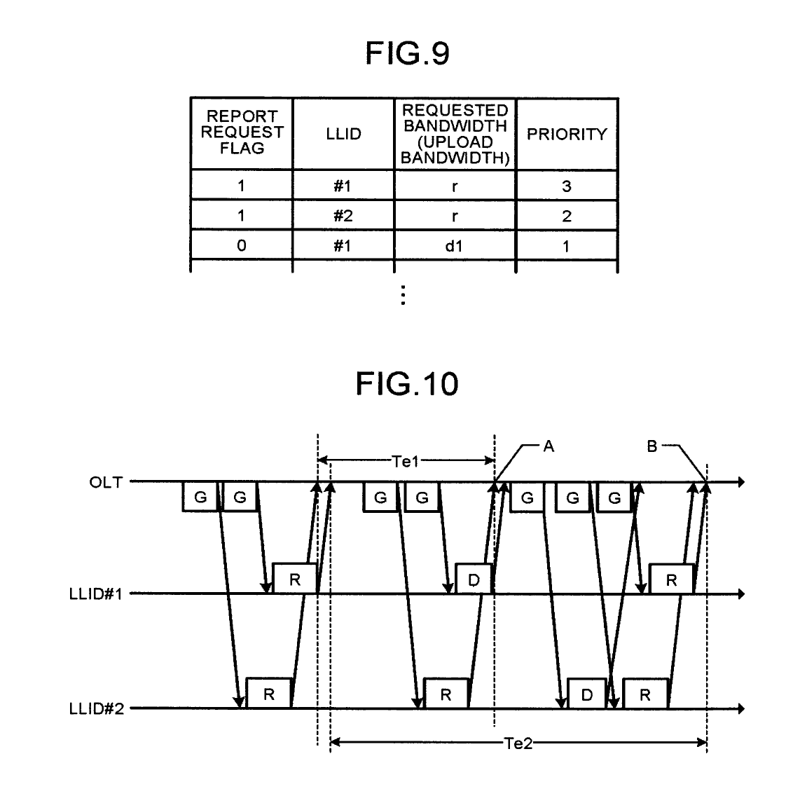

Next, a detailed operation in the bandwidth allocation process according to the present embodiment is described. FIG. 8 is a flowchart illustrating a procedure example of the bandwidth allocation process according to the present embodiment. FIG. 9 is a diagram illustrating an example configuration of an allocation order table. The OLT 1 according to the present embodiment holds an allocation order table as described in the explanations of FIG. 1.

In the present embodiment, a bandwidth allocation cycle is not set, and the transmission order in an upload bandwidth is decided according to the priority decided on the basis of the remaining time (residual time) before the allowable delay time. Therefore, the upload-bandwidth calculation unit 111 does not decide the order of giving transmission permission, but calculates the transmission-permitted duration (or data volume) as an upload bandwidth on the basis of the transmission queue length and the upload-communication data rate.

Each individual row (entry) in the allocation order table corresponds to each individual bandwidth allocation request. In each row, allocation information indicating specifics of the bandwidth allocation request is stored. A bandwidth allocation request registered in the allocation order table includes a report request and a data request. The report request is a bandwidth allocation request for transmitting a report frame. The data request is a bandwidth allocation request for transmitting user data. As illustrated in FIG. 9, the allocation order table is configured by a report request flag indicating whether the request is a report request (a first request) or a data request (a second request), an LLID indicating a bandwidth-allocation request source, a requested bandwidth indicating a requested bandwidth to be allocated, and a priority. That is, in the example in FIG. 9, as allocation information corresponding to each bandwidth allocation request, the report request flag, the requested bandwidth, and the priority are stored in the allocation order table. In the example in FIG. 9, the report request flag indicates a report request when the report request flag is ON (“1”), and indicates a data request when the report request flag is OFF (“0”). Note that FIG. 9 merely illustrates an example, and the format of the allocation order table, the report-request-flag definition method, and the like are not limited to the example in FIG. 9.

The report-request registration unit 105 registers a report request in the allocation order table. The data-request registration unit 110 registers a data request in the allocation order table. A data request from each LLID is registered when an upload bandwidth is allocated to the LLID.

When a data request is registered, the data-request registration unit 110 registers OFF (“0”) as a data request flag for each LLID, and registers an upload bandwidth allocated to each LLID (the transmission-permitted data volume or the transmission-permitted duration), which is calculated by the upload-bandwidth calculation unit 111 as a requested bandwidth. The data-request registration unit 110 registers a priority calculated by the residual-time calculation unit 103 and the priority calculation unit 104 using a method described below.

The residual-time calculation unit 103 calculates a residual time using the following expression (1), for example.

Residual time=Allowable delay time (Ta)−Elapsed time since last report-frame reception (Te) (1)

The allowable delay time (Ta) is an allowable time for the time period (a delay time) from the time when the ONUs 2-1 to 2-3 receive data from the transmission-reception units 24-1 and 24-2 to the time when the OLT 1 receives that data. For example, the allowable delay time (Ta) is decided on the basis of data calculated by the OLT 1 when linking up. The residual-time calculation unit 103 holds the allowable delay time (Ta) for each LLID. This allowable delay time is decided so as to fall within a guaranteed delay time for user data (guaranteed delay time≧allowable delay time). For example, where the guaranteed delay time is represented as Tp, the maximum value of the time required for the ONUs 2-1 to 2-3, from the arrival of upload user data, to transmit a report frame related to the user data is acquired in advance, and a value obtained by subtracting the acquired maximum value from Tp is used as the allowable delay time. The guaranteed delay time is decided according to the service type or other factors. The OLT 1 can obtain a guaranteed delay time for each LLID to acquire an allowable delay time from the guaranteed delay time, or can directly acquire an allowable delay time on the basis of the service type or other factors. There are multiple possible methods for setting an allowable delay time as described below, for example. The method for setting an allowable delay time is not limited to the examples described below.
(i) As a service-level parameter, an allowable delay time is set to each LLID by an operator. For another example, a delay class is set to each LLID by an operator, and the OLT 1 holds a correspondence between the delay class and the allowable delay time to calculate the allowable delay time according to the delay class.
(ii) The service type (such as VoIP/Video) is set by an operator, and the OLT 1 holds a correspondence between the service type and the allowable delay time to calculate the allowable delay time on the basis of the service type having been set to each LLID.
(iii) The OLT 1 holds a correspondence between the allowable delay time and the value of information indicative of the service type (such as the Tos (Type of Service) value, the Cos (Class of Service) value, or the VID (VLAN (Virtual Local Area Network) IDentifier) value) stored in a transmission frame, and calculates the allowable delay time for each LLID on the basis of the information (such as the Tos value, the Cos value, or the VID value) stored in an upload transmission frame of each LLID.

The elapsed time (Te) since the last report-frame reception is an elapsed time since reception of the last report frame from a target LLID. The residual-time calculation unit 103 holds the receiving time of the last report frame from each LLID. In a case where there is not the last report-frame receiving time (when initially receiving a report frame), Te is set at a predetermined initial value (0, for example).

The elapsed time (Te) since the last report-frame reception is used as an estimated value of an elapsed time since user data, to which bandwidth allocation is requested by a report frame, arrives at the ONUs 2-1 to 2-3 (a time for which user data stays in the ONUs 2-1 to 2-3). A value other than the elapsed time since the last report-frame reception can also be used. For example, in place of the elapsed time since the last report-frame reception, a value, which is obtained by subtracting RTT (Round Trip Time)/2 from an elapsed time since the transmission start time instructed to a target LLID, can also be used as the above Te. Normally, the OLT 1 measures RTT, and this measurement value is used.

The priority calculation unit 104 uses the residual time acquired by the above expression (1) so as to acquire a priority according to the following expression (2).

Priority=(“a”−Residual time)×“b” +Upload bandwidth of target LLID×“c” (2)

“a”, “b”, and “c” are preset constants, and the upload bandwidth of a target LLID is an upload bandwidth calculated by the upload-bandwidth calculation unit 111. “a”, “b”, and “c” can be changed. In this example, a larger numerical value of the priority indicates a higher priority. The above expression (2) is merely an example. The priority deciding method is not limited to the above expression (2). Any priority deciding method can be used as long as the priority becomes higher as the residual time is reduced. Further, the priority can be acquired in advance according to respective ranges of the residual time and the upload bandwidth of a target LLID, and is held as a table to acquire a priority by referring to the table.

When registering a report request, the report-request registration unit 105 registers ON (“1”) as a report request flag, and registers the time required to transmit a report frame (or the data volume of a report frame) as a requested bandwidth. There are various possible methods as a method for registering a report request in an allocation order table. While two examples are described below, a method other than these two examples can also be adopted.

Registration method 1: A report request is registered in cycles. A report-request registering cycle (hereinafter, “report registration cycle”) is shorter than a cycle Tr decided on the basis of an allowable delay time in order to transmit a report request (a transmission interval to transmit a report frame such that a user-data delay time falls within an allowable delay time). The cycle Tr is equal to or shorter than the allowable delay time. For example, it is conceivable that the maximum value of the time required for the ONUs 2-1 to 2-3, from the arrival of upload user data, to transmit a report frame related to the user data is acquired in advance, and a value obtained by subtracting the acquired maximum value from the allowable delay time is used as the cycle Tr. When registering a report request, a sufficiently high priority (for example, a value as large as the maximum value of a priority to a data request described later) is registered. Further, the priority of a report request can be decided according to the service type of an LLID or other factors. When registering a report request, when there is a bandwidth allocation request with a higher priority than the report request, a bandwidth is allocated to the report request subsequently to the request with a higher priority. The report registration cycle is set shorter than the cycle Tr so as to perform bandwidth allocation to a report request during the lapse of Tr since the last report-frame transmission, even when bandwidth allocation to the report request is delayed to some extent from the registration time due to giving a higher priority to another bandwidth allocation request as described above. Further, by setting the report registration cycle shorter than the cycle Tr, transmission of a report request can be advanced forward to an open time slot in which upload communication is not congested, as illustrated in FIG. 7. Furthermore, it is desirable to set the priority of a report request higher at the time when an elapsed time (Tf) since the last report-frame transmission reaches Tr.

For example, the elapsed time (Tf) since the last report-frame transmission is used to acquire “Tr−Tf”, which is defined as a residual time of a report request. A calculation expression is defined, from which a higher priority is derived as the residual time of a report request is shorter. The residual time of a report request is substituted into the calculation expression to acquire a priority. It is conceivable to use the following expression (3) as this calculation expression, for example.

Priority=(“a′”−Residual time of report request)×“b′”+“d” (3)

“a′”, “b′”, and “d” are preset constants. “a′”, “b′”, and “d” can be changed.

Registration method 2: Upon reception of a report frame, the next report request of an LLID corresponding to the received report frame is registered. A priority is decided so as to become sufficiently high when the elapsed time since the last report-frame reception reaches the cycle Tr that is decided on the basis of an allowable delay time for each LLID in order to transmit a report request. It is conceivable as an example that when registered, the initial value of a priority is set not to be relatively high, and when updating the priority of a report request with the timing of updating an allocation order table, the priority is updated to become higher as the elapsed time since the time of registering the report request (that is, the time of receiving the last report frame) becomes closer to Tr. For example, it is conceivable to use the above expression (3) as described in the “registration method 1”.

With reference to FIG. 8, the bandwidth allocation process in the OLT 1 is described. In the OLT 1, the allocation-order reading unit 107 refers to an allocation order table; reads information on the highest-priority entry; and outputs the information to the gate-frame creation unit 108 (Step S1). On the basis of the input information, the gate-frame creation unit 108 generates and transmits a gate frame to the ONUs 2-1 to 2-3 (issues a gate) via the download-data multiplexing unit 109 and the optical transmission unit 15 (Step S2). Next, the report-frame analysis unit 102 determines whether a report frame has been received (Step S3). When a report frame has been received (YES at Step S3), the report-frame analysis unit 102 provides the transmission queue length stored in the report frame to the upload-bandwidth calculation unit 111. The upload-bandwidth calculation unit 111 calculates an upload bandwidth (Step S5).

The residual-time calculation unit 103 calculates a residual time on the basis of the expression (1) as described above with respect to the report-frame receiving time (Step S6). The priority calculation unit 104 calculates a priority on the basis of the residual time as described above (Step S7). The data-request registration unit 110 uses the priority calculated at Step S7 so as to register a data request in the allocation order table (Step S8). The bandwidth allocation process returns to Step S1. At Step S8, the allocation-order updating unit 106 recalculates the priority of an already-registered entry, and updates the allocation order table using the recalculated result. In the recalculation, on the basis of a recalculation instruction from the allocation-order updating unit 106 for example, the priority is calculated by the residual-time calculation unit 103 and the priority calculation unit 104 on the basis of Ta and Te at the current point in time. In the case of recalculating the priority of a report request, the report-request registration unit 105 recalculates the priority on the basis of a recalculation instruction from the allocation-order updating unit 106. For another example, on the basis of Ta, Te, and the like at the current point in time, the allocation-order updating unit 106 can perform the same calculation as performed by the residual-time calculation unit 103 and the priority calculation unit 104, or by the report-request registration unit 105, in order to acquire a priority.

Further, at Step S3, when a report frame has not been received (NO at Step S3), the report-request registration unit 105 determines whether it is a report-request registration timing (Step S4). When it is not the registration timing (NO at Step S4), the bandwidth allocation process returns to Step S1. When it is the report-request registration timing (YES at Step S4), the bandwidth allocation process advances to Step S8 so as to register a report request in the allocation order table. At this time, the allocation-order updating unit 106 recalculates the priority of an already-registered entry, and updates the allocation order table using the recalculated result.

In the flowchart described above, the priority of an already-registered entry is also updated when each bandwidth allocation request is registered in the allocation order table. There is a case where the allocation-order reading unit 107 is set to read an entry with a priority equal to greater than a given value. In this case, at the time other than the time of registering each bandwidth allocation request in the allocation order table, the priority of a bandwidth allocation request, which is close to a residual time (a residual time of a report request in the case of a report frame), is also updated to become higher. The timing of updating the priority of an already-registered entry is not limited to the example described above. Independently from the registration in the allocation order table, the priority of an already-registered entry can be updated at a given time interval, for example.

FIG. 10 is an explanatory diagram of an elapsed time since the last report reception. In FIG. 10, “R” represents a report frame, “G” represents a gate frame, and “D” represents data (upload user data). At the A-point in FIG. 10, the OLT 1 receives a report frame from the LLID #2, and the allocation order table is updated. At this time, at the A-point, the elapsed time since the time of receiving the last report frame from the LLID #1 is represented as Te1 illustrated in FIG. 10. Therefore, Te1 is used as Te in the above expression (1) to calculate (to update) a priority of a data request and a report request from the LLID #1. At the B-point in FIG. 10, the OLT 1 receives a report frame from the LLID #1, and the allocation order table is updated. At this time, at the B-point, the elapsed time since the time of receiving the last report frame from the LLID #2 is represented as Te2 illustrated in FIG. 10. Therefore, Te2 is used as Te in the above expression (1) to calculate (to update) a priority of a data request and a report request from the LLID #2.

In the present embodiment, the priority of a data request is decided on the basis of a residual time before an allowable delay time, and on the basis of an upload bandwidth, and the priority of a report request is decided on the basis of the time up until the report-request transmission interval on the basis of the allowable delay time. The present invention is not limited thereto, and the priority of a data request can be decided on the basis of a residual time without taking into account an upload bandwidth. In this case, instead of the priority, a residual time (a residual time of a report request in the case of a report request) can be stored in the allocation order table. The allocation-order updating unit 106 can calculate a priority on the basis of the residual time when the allocation order table is updated, and can sort the allocation order table in order of the highest priority.

In the case of using a gate frame so as to notify a bandwidth allocation result, the maximum value of transmission time period allocatable to each LLID is 0×FFFF [tq] (approximately 1.049 [milliseconds]) in terms of the gate-frame format specifications. When there are constrains to the transmission time period allocatable to each LLID at a time as described above, un upload bandwidth to be allocated to each LLID is equal to or less than the maximum value of this transmission time period. When one LLID requests allocation of a greater bandwidth at a time, there is a possibility of a delay in bandwidth allocation to another LLID. Therefore, an upper limit to an upload bandwidth to be allocated to one single LLID at one single time can be set.

While in the present embodiment, a bandwidth is allocated without setting a bandwidth allocation cycle, the bandwidth allocation cycle can be set. In this case, in each bandwidth allocation cycle, the order of allocation priority can be decided on the basis of the residual time as described above.

As described above, in the present embodiment, without setting a fixed allocation cycle, the priority of a data request is decided on the basis of a residual time before an allowable delay time and on the basis of an upload bandwidth. Also, the priority of a report request is decided on the basis of a residual time before the report-frame transmitting timing decided on the basis of an allowable delay time of the report frame. On the basis of the priority, the bandwidth allocating order (an upload transmitting order) is decided. Therefore, it is possible to dynamically vary the number of bursts per unit time and the allocation cycle of each LLID depending on the line congestion state. Accordingly, while maintaining the required bandwidth usage efficiency, delay guarantee can be provided. When the method according to the present embodiment is used, in which the allocation order is controlled by a priority, the allocation cycle is varied depending on the communication state within a bandwidth.

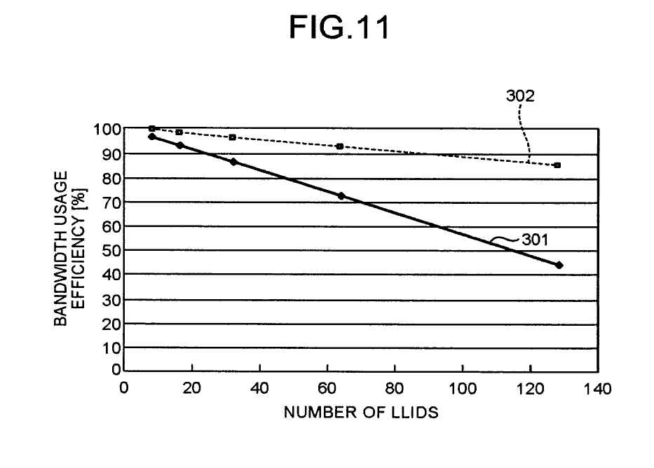

FIG. 11 is an explanatory diagram of the effects of the present embodiment. Bandwidth usage efficiency 301 indicates bandwidth usage efficiency when the conventional bandwidth allocation method is used. Bandwidth usage efficiency 302 indicates bandwidth usage efficiency when the bandwidth allocation method according to the present embodiment is used. As illustrated in FIG. 11, in the present embodiment, the bandwidth usage efficiency can be improved as compared to the conventional bandwidth allocation method. Particularly, as the number of LLIDs increases, the bandwidth usage efficiency is improved more significantly.

### INDUSTRIAL APPLICABILITY

As described above, the master station device, the slave station device, the optical communication system, the control device, and the bandwidth allocation method according to the present invention are useful in a PON system, and are particularly suitable for a PON system that guarantees a delay time of upload communication.

### REFERENCE SIGNS LIST

1 OLT, 2-1 to 2-3 ONU, 3 coupler, 4 optical fiber, 11 optical reception unit, 12, 22 PON control unit, 13 upload-data transmission unit, 14 download-data reception unit, 15 optical transmission unit, 21 optical reception unit, 23 optical transmission unit, 24-1, 24-2 transmission-reception unit, 25 transmission buffer, 101 upload-data distribution unit, 102 report-frame analysis unit, 103 residual-time calculation unit, 104 priority calculation unit, 105 report-request registration unit, 106 allocation-order updating unit, 107 allocation-order reading unit, 108 gate-frame creation unit, 109 download-data multiplexing unit, 110 data-request registration unit, 111 upload-bandwidth calculation unit.

1. A master station device that is connected to one or more slave station devices through an optical communication path and that allocates a bandwidth for communication in an upload direction, which is a direction from the slave station devices toward the master station device itself, to each of the slave station devices per logical link, the master station device comprising:
an analysis unit
that receives a bandwidth request signal requesting a bandwidth for transmitting upload data from the slave station device, and
that extracts a requested bandwidth of each logical link from the bandwidth request signal;
a bandwidth calculation unit that calculates an upload bandwidth for transmitting the upload data on the basis of the requested bandwidth;
a residual-time calculation unit that
holds an allowable delay time for each logical link for communication in an upload direction, and
that acquires a residual time of each logical link on the basis of the allowable delay time and an estimated value of a time for which the upload data stays in the slave station device;
a priority calculation unit that acquires a priority of a bandwidth allocation request for transmitting the upload data, which is requested by the bandwidth request signal, on the basis of the residual time of each logical link;
a bandwidth-request generation unit
that generates a bandwidth allocation request, which requests allocation of an upload bandwidth for transmitting a bandwidth request signal, for each logical link and
that decides a priority of a generated bandwidth allocation request;
an allocation-order decision unit that decides an allocation order corresponding to the bandwidth allocation request on the basis of the priority; and
a transmission-permission generation unit
that decides a transmission-permitted time slot corresponding to the bandwidth allocation request on the basis of the allocation order and on the basis of the upload bandwidth in each of the bandwidth allocation requests, and
that notifies the slave station device of the transmission-permitted time slot.

2. The master station device according to claim 1, wherein
the priority calculation unit
defines the residual time as a value obtained by subtracting an estimated value of a time, for which the upload data stays in the slave station device, from the allowable delay time, and
calculates the priority such that the priority becomes higher as the residual time is reduced.

3. The master station device according to claim 1, wherein
the priority calculation unit reacquires a priority of a bandwidth allocation request of the upload data on the basis of the upload bandwidth.

4. The master station device according to claim 3, wherein
the priority calculation unit calculates the priority such that the priority becomes higher as the upload bandwidth is reduced.

5. The master station device according to claim 1, wherein
the bandwidth-request generation unit calculates the priority such that the priority becomes higher as a time is reduced that is obtained by subtracting an elapsed time since transmission of a last bandwidth request signal from a minimum transmission interval,
the minimum transmission interval being required to transmit a bandwidth request signal is set on the basis of the allowable delay time.

6. The master station device according to claim 1, further comprising:
an allocation-information updating unit
that holds a flag, a logical link identifier, the priority, and the upload bandwidth of each of the bandwidth requests as allocation information, and
that updates a value of a priority in the allocation information, where
the flag indicates whichever the corresponding bandwidth allocation request is either a first allocation request that is a bandwidth allocation request for transmitting a bandwidth request signal or a second allocation request that is a bandwidth allocation request for transmitting upload data; and
a data-request generation unit that registers, as the allocation information when the data-request generation unit receives the bandwidth request signal, the flag in which a value indicative of a second allocation request is set, a logical link identifier, and an upload bandwidth calculated by the bandwidth calculation unit, wherein
the allocation-order decision unit
reads the allocation information in order of the highest priority, and
determines the allocation order by outputting read information to the transmission-permission generation unit,
the bandwidth-request generation unit registers, as the allocation information when the bandwidth allocation request is generated, the flag in which a value indicative of a first allocation request is set, a logical link identifier, and an upload bandwidth for transmitting the bandwidth request signal, and
the transmission-permission generation unit decides the transmission-permitted time slot on the basis of the allocation information output from the allocation-order decision unit.

7. The master station device according to claim 6, wherein
the allocation-information updating unit, when the allocation information is to be registered, updates a value of a priority in the allocation information that has already been already registered other than the allocation information to be registered.

8. The master station device according to claim 1, wherein
the allocation-information updating unit updates a value of a priority in the allocation information during a predetermined cycle.

9. The master station device according to claim 1, wherein
the bandwidth-request generation unit generates the bandwidth allocation request for each logical link during a given cycle that is shorter than the allowable delay time.

10. The master station device according to claim 1, wherein
the bandwidth-request generation unit, when receiving the bandwidth request signal, generates the bandwidth allocation request for a logical link corresponding to the received bandwidth request signal.

11. The master station device according to claim 1, wherein
an estimated value of a time, for which the upload data stays in the slave station device, is defined as an elapsed time since reception of a last bandwidth request signal.

12. The master station device according to claim 1, wherein
an estimated value of a time, for which the upload data stays in the slave station device, is defined as a value obtained by subtracting one-half of a round-trip delay time from an elapsed time since a transmission start time in a last instructed transmission-permitted time slot.

13. A slave station device connected to a master station device through an optical communication path, where a bandwidth for communication in an upload direction that is a direction toward the master station device is allocated to the slave station device per logical link by the master station device, wherein
the slave station device transmits to the master station device a bandwidth request signal for each logical link and in which a requested bandwidth for transmitting upload data from the slave station device itself is stored, and
the slave station device
receives from the master station device a transmission-permitted time slot to which each logical link is set according to an allocation order for a bandwidth allocation request on the basis of the bandwidth request signal and for a bandwidth allocation request for transmitting the bandwidth request signal, which is determined on the basis of an allowable delay time for each logical link for communication in an upload direction, and
transmits the bandwidth request signal and the upload data on the basis of the transmission-permitted time slot.

14. An optical communication system comprising: a master station device; and one or more slave station devices connected to the master station device through an optical communication path, where a bandwidth for communication in an upload direction that is a direction from the slave station devices toward the master station device is allocated to each of the slave station devices by the master station device, wherein
the slave station device transmits to the master station device a bandwidth request signal for each logical link and in which a requested bandwidth for transmitting upload data from the slave station device itself is stored,
the master station device includes
an analysis unit that receives the bandwidth request signal from the slave station device and that extracts the requested bandwidth for each logical link from the bandwidth request signal,
a bandwidth calculation unit that calculates, on the basis of the requested bandwidth, an upload bandwidth for transmitting the upload data,
a residual-time calculation unit that holds an allowable delay time for each logical link for communication in an upload direction and that acquires a residual time of each logical link on the basis of the allowable delay time and an estimated value of a time for which the upload data stays in the slave station device,
a priority calculation unit that acquires, on the basis of the residual time of each logical link, a priority of a bandwidth allocation request for transmitting the upload data, which is requested by the bandwidth request signal,
a bandwidth-request generation unit that generates a bandwidth allocation request for each logical link and which requests allocation of an upload bandwidth for transmitting a bandwidth request signal and that determines a priority of a generated bandwidth allocation request,
an allocation-order decision unit that decides, on the basis of the priority, an allocation order corresponding to the bandwidth allocation request, and
a transmission-permission generation unit that decides a transmission-permitted time slot corresponding to the bandwidth allocation request on the basis of the allocation order and on the basis of the upload bandwidth in each of the bandwidth allocation requests and that notifies the slave station device of the transmission-permitted time slot, and
the slave station device transmits the bandwidth request signal and the upload data on the basis of the transmission-permitted time slot notified from the master station device.

15. A control device in a master station device that is connected to one or more slave station devices through an optical communication path and that allocates a bandwidth for communication in an upload direction, which is a direction from the slave station devices toward the master station device itself, to each of the slave station devices per logical link, the control device comprising:
an analysis unit that receives a bandwidth request signal, requesting a bandwidth for transmitting upload data, from the slave station device, and that extracts a requested bandwidth for each logical link from the bandwidth request signal;
a bandwidth calculation unit that calculates, on the basis of the requested bandwidth, an upload bandwidth for transmitting the upload data;
a residual-time calculation unit that holds an allowable delay time for each logical link for communication in an upload direction and that acquires, on the basis of the allowable delay time and an estimated value of a time for which the upload data stays in the slave station device, a residual time of each logical link;
a priority calculation unit that acquires, on the basis of the residual time of each logical link, a priority of a bandwidth allocation request for transmitting the upload data, which is requested by the bandwidth request signal;
a bandwidth-request generation unit that generates a bandwidth allocation request for each logical link, which requests allocation of an upload bandwidth for transmitting a bandwidth request signal, and that decides a priority of a generated bandwidth allocation request;
an allocation-order decision unit that decides, on the basis of the priority, an allocation order corresponding to the bandwidth allocation request; and
a transmission-permission generation unit that decides a transmission-permitted time slot corresponding to the bandwidth allocation request on the basis of the allocation order and on the basis of the upload bandwidth in each of the bandwidth allocation requests and that notifies the slave station device of the transmission-permitted time slot.

16. A control device in a slave station device connected to a master station device through an optical communication path, where a bandwidth for communication in an upload direction that is a direction toward the master station device is allocated to the slave station device per logical link by the master station device, wherein
the control device transmits to the master station device a bandwidth request signal for each logical link, in which a requested bandwidth for transmitting upload data from the control device itself is stored, and
the control device
receives from the master station device a transmission-permitted time slot to which each logical link is set according to an allocation order for a bandwidth allocation request on the basis of the bandwidth request signal and for a bandwidth allocation request for transmitting the bandwidth request signal, which is decided in the master station device on the basis of an allowable delay time for each logical link for communication in an upload direction, and
transmits the bandwidth request signal and the upload data on the basis of the transmission-permitted time slot.

17. A bandwidth allocation method in an optical communication system including a master station device and one or more slave station devices connected to the master station device through an optical communication path, where a bandwidth for communication in an upload direction that is a direction from the slave station devices toward the master station device is allocated to each of the slave station devices by the master station device, the bandwidth allocation method comprising:
a request-signal transmitting step, performed by the slave station device, of transmitting to the master station device a bandwidth request signal for each logical link, in which a requested bandwidth for transmitting upload data from the slave station device itself is stored;
an analyzing, performed by the master station device, of receiving the bandwidth request signal from the slave station device and extracting the requested bandwidth for each logical link from the bandwidth request signal;
a bandwidth calculating, performed by the master station device, of calculating an upload bandwidth for transmitting the upload data on the basis of the requested bandwidth;
a residual-time calculating, performed by the master station device, of holding an allowable delay time for each logical link for communication in an upload direction and acquiring a residual time of each logical link on the basis of the allowable delay time and an estimated value of a time for which the upload data stays in the slave station device;
a priority calculating, performed by the master station device, of acquiring a priority of a bandwidth allocation request for transmitting the upload data, which is requested by the bandwidth request signal, on the basis of the residual time of each logical link;
a bandwidth-request generating, performed by the master station device, of generating a bandwidth allocation request from each logical link, which requests allocation of an upload bandwidth for transmitting a bandwidth request signal, and deciding a priority of a generated bandwidth allocation request;
an allocation-order deciding, performed by the master station device, of deciding an allocation order corresponding to the bandwidth allocation request on the basis of the priority;
a transmission-permission generating, performed by the master station device, of deciding a transmission-permitted time slot corresponding to the bandwidth allocation request on the basis of the allocation order and on the basis of the upload bandwidth in each of the bandwidth allocation requests and notifying the slave station device of the transmission-permitted time slot; and
a transmission controlling, performed by the slave station device, of transmitting the bandwidth request signal and the upload data on the basis of the transmission-permitted time slot notified from the master station device.
